(19) United States
(12) Patent Application Publication
(10) Pub. No.: US 2025/0219729 A1
(43) Pub. Date: Jul. 3, 2025

(54) FREE SPACE OPTICAL COMMUNICATION SYSTEM, MANAGEMENT APPARATUS, AND FREE SPACE OPTICAL COMMUNICATION APPARATUS

(71) Applicant: NEC Corporation, Minato-ku (JP)

(72) Inventors: Hisashi TSURUTA, T0okyo (JP); Hisashi Mizumoto, Tokyo (JP)

(73) Assignee: NEC Corporation, Minato-ku (JP)

(21) Appl. No.: 18/398,508

(22) Filed: Dec. 28, 2023

(51) Int. Cl. H04B 10/112; H04B 10/071

(52) U.S. Cl. CPC H04B 10/1123; H04B 10/071

(57) ABSTRACT

Provided is a technique that makes it possible to detect movement of a target. A free space optical communication system includes: a plurality of free space optical communication apparatuses constituting a meshed-form free space optical communication network; and at least one processor, the at least one processor executing a detection process of detecting movement of a target in an area of the meshed-form free space optical communication network on the basis of light reception states of the respective free space optical communication apparatuses.

This Nonprovisional application claims priority under 35 U.S.C. § 119 on Patent Application No. 2023-001830 filed in Japan on Jan. 10, 2023, the entire contents of which are hereby incorporated by reference.

### TECHNICAL FIELD

The present invention relates to a free space optical communication system, a management apparatus, and a free space optical communication apparatus.

### BACKGROUND ART

There have been known active sensors that dynamically sense, e.g., an invader, an approaching car, and/or an approaching person for the purpose of crime prevention. An active sensor for crime prevention is set at an entrance, a window, a parking space, and/or the like in order to detect an invader. Roughly two types of active sensors are known. One type of active sensor includes two sensors respectively disposed on the left and right. One of the two sensors emits infrared ray light in the form of a line, and the other of the two sensors receives the light. Interruption of the infrared ray is detected as an invader. The other type of active sensor includes a single sensor that emits light toward a target. When the single sensor detects the light reflected by the target, the detection is determined as detection of an invader.

For example, Patent Literature 1 discloses a technique that uses: a transmitter and a receiver each for a laser beam; a reflector that is rotatable around an axis and that has a peripheral surface constituted by a plurality of planes; and a reflection sheet, attached to a moving object that is to be detected, which is configured to reflect a laser beam. According to this technique, the transmitter transmits a laser beam toward the peripheral surface of the reflector that is rotating. Then, the laser beam is expanded by the reflector, so as to continuously scan a detection area on a certain plane or a certain line. Then, when reflected light from the reflection sheet is received by the receiver, the reception is determined as the moving object entering the detection area.

### CITATION LIST

### Patent Literature

[Patent Literature 1]

Japanese Patent Application Publication, Tokukaihei, No. H10-2962 (1998)

### SUMMARY OF INVENTION

### Technical Problem

However, in order to use the technique disclosed in Patent Literature 1 to detect invasion of an invader and thereafter detect movement of the invader, this technique needs to be combined with a security camera and/or a security guard coming to the aid. When combined with the security camera, this technique involves the following disadvantage. That is, when the invader enters a place which is difficult to see, e.g., a blind spot, the invader may be missed. Meanwhile, when combined with the security guard coming to the aid, this technique involves the following disadvantage. That is, due to a time lag between detection and arrival of the security guard, the invader may be missed.

Further, it is beneficial to detect movement of a target other than the invader, such as a pedestrian, in addition to an invader.

An example aspect of the present invention was made in view of the above problem, and has an example object to provide a technique capable of detecting movement of a target.

### Solution to Problem

A free space optical communication system in accordance with an example aspect of the present invention includes: a plurality of free space optical communication apparatuses constituting a meshed-form free space optical communication network; and at least one processor, the at least one processor executing: a detection process of detecting movement of a target in an area of the meshed-form free space optical communication network on a basis of light reception states of the respective plurality of free space optical communication apparatuses.

A management apparatus in accordance with an example aspect of the present invention includes: at least one processor, the at least one processor executing: a detection process of detecting movement of a target in an area of a meshed-form free space optical communication network on a basis of light reception states of a respective plurality of free space optical communication apparatuses constituting the meshed-form free space optical communication network.

A free space optical communication apparatus in accordance with an example aspect of the present invention is a free space optical communication apparatus which is included in a plurality of free space optical communication apparatuses constituting a meshed-form free space optical communication network, the free space optical communication apparatus including: at least one processor, the at least one processor executing: a detection process of detecting, on a basis of a light reception state of the free space optical communication apparatus, movement of a target which is in a vicinity of the free space optical communication apparatus in an area of the meshed-form free space optical communication network.

### Advantageous Effects of Invention

According to an example aspect of the present invention, it is possible to detect movement of a target.

### BRIEF DESCRIPTION OF DRAWINGS

FIG. 1 is a block diagram illustrating an example of a configuration of a free space optical communication system in accordance with a first example embodiment of the present invention.

FIG. 2 is a block diagram schematically illustrating an example of a configuration of a management apparatus in accordance with the first example embodiment of the present invention.

FIG. 3 is a block diagram schematically illustrating an example of a configuration of a free space optical communication apparatus in accordance with the first example embodiment of the present invention.

FIG. 4 is a block diagram schematically illustrating an example of a configuration of a free space optical communication system in accordance with a second example embodiment of the present invention.

FIG. 5 is a block diagram schematically illustrating an example of a configuration of a management apparatus in accordance with the second example embodiment of the present invention.

FIG. 6 is a block diagram schematically illustrating an example of a configuration of a free space optical communication apparatus in accordance with the second example embodiment of the present invention.

FIG. 7 is a view schematically illustrating an example of a configuration of a light emitting unit in the free space optical communication apparatus in accordance with the second example embodiment of the present invention.

FIG. 8 is a view schematically illustrating an example of a configuration of a light receiving unit in the free space optical communication apparatus in accordance with the second example embodiment of the present invention.

FIG. 9 is a view schematically illustrating an example of free space optical communication between two free space optical communication apparatuses in the free space optical communication system in accordance with the second example embodiment of the present invention.

FIG. 10 is a view schematically illustrating an example in which the free space optical communication between the two free space optical communication apparatuses in the free space optical communication system in accordance with the second example embodiment of the present invention is interrupted.

FIG. 11 is a flowchart schematically illustrating an example control of the free space optical communication system in accordance with the second example embodiment of the present invention.

FIG. 12 is a flowchart schematically illustrating an example control of the free space optical communication system in accordance with the second example embodiment of the present invention.

FIG. 13 is a flowchart schematically illustrating an example control of a free space optical communication system in accordance with a third example embodiment of the present invention.

FIG. 14 is a flowchart schematically illustrating an example control of a free space optical communication system in accordance with a fourth example embodiment of the present invention.

FIG. 15 is a flowchart schematically illustrating an example control of a free space optical communication system in accordance with a fifth example embodiment of the present invention.

FIG. 16 is a view schematically illustrating an example of a configuration of a computer.

### DESCRIPTION OF EMBODIMENTS

### First Example Embodiment

The following description will discuss a first example embodiment of the present invention in detail with reference to the drawings. The present example embodiment is a basic form of example embodiments described later.

### Example of Configuration of Free Space Optical Communication System

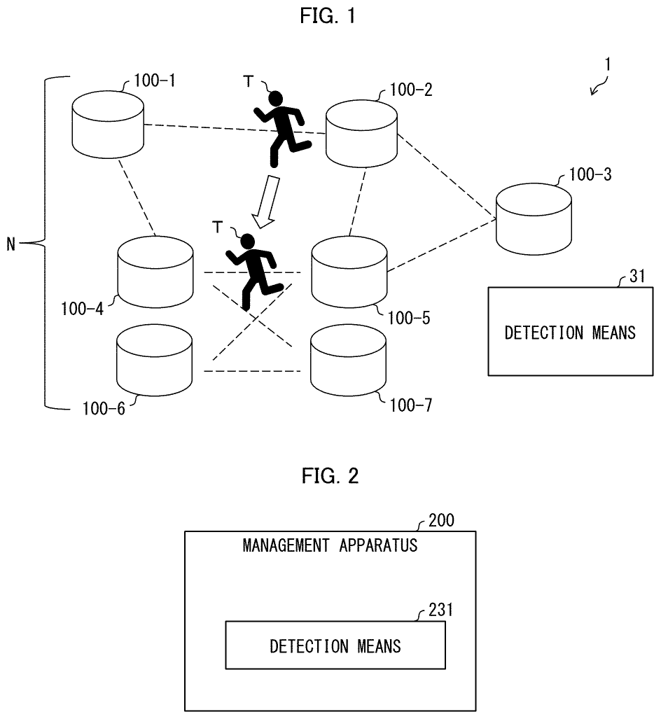

The following will describe, with reference to FIG. 1, a configuration of a free space optical communication system 1 in accordance with the present example embodiment. FIG. 1 is a block diagram schematically illustrating an example of a configuration of the free space optical communication system 1. The free space optical communication system 1 is a communication system that carries out free space optical communication. The free space optical communication refers to communication involving use of light propagating in a space. Examples of the light used in the free space optical communication can encompass millimeter wave, submillimeter wave, infrared light, visible light, and ultraviolet light.

The free space optical communication system 1 includes a plurality of free space optical communication apparatuses constituting a meshed-form free space optical 100 communication network N. The meshed-form free space optical communication network refers to a free space optical communication network including at least one mesh formed by free space optical communication paths. The example in FIG. 1 shows seven free space optical communication apparatuses 100-1 to 100-7 (if there is no need to distinguish the free space optical communication apparatuses from each other, the term “free space optical communication apparatus 100” may simply be used). However, the number of free space optical communication apparatuses is not limited to this.

In the free space optical communication apparatuses 100-1 to 100-7, the free space optical communication apparatuses 100 use light to carry out one-way or bidirectional communication with each other so as to form a communication network including a mesh(es). Light emitted from each of the free space optical communication apparatuses 100 and received by another one of the free space optical communication apparatuses 100 is a directional optical communication medium. A specific example thereof may be electromagnetic wave of a high frequency region including a frequency of not less than approximately 10 GHz. However, the present example embodiment is not limited to this. Examples of the electromagnetic wave of the frequency region encompass millimeter wave, submillimeter wave, infrared light, visible light, and ultraviolet light.

In an example, each of the free space optical communication apparatuses 100 emits electromagnetic wave of the above frequency region such that the electromagnetic wave is directed at an angle within a given angle range, thereby using the electromagnetic wave for communication as the above-described directional optical communication medium. Here, in a specific example, in order to direct the electromagnetic wave of the above frequency region, each of the free space optical communication apparatuses 100 may be configured to include, for example, the followings:
A beam forming antenna that emits millimeter wave or submillimeter wave in such a manner that the millimeter wave or the submillimeter wave is directed at an angle within a given angle range;
A collimator that collimates infrared light, visible light, or ultraviolet light;
A laser oscillator that generates a laser beam of infrared light, visible light, or ultraviolet light; and/or
A free space optical modulator that modulates a laser beam by changing the phase of crystal.

However, the present example embodiment is not limited to such a configuration.

Further, the free space optical communication system 1 includes a detection means 31. The detection means 31 detects movement of a target T in an area of the meshed-form free space optical communication network N on the basis of a light reception state of its corresponding free space optical communication apparatus 100.

That is, on the basis of the light reception states of the respective free space optical communication apparatuses 100, the detection means 31 can detect that the target T has interrupted free space optical communication on a free space optical communication path. Consequently, the detection means 31 can detect a position where the target T moves. Here, the plurality of free space optical communication apparatuses 100 constitute the meshed-form free space optical communication network N having a mesh topology. Thus, it is possible to monitor movement of the target T in a plane. This makes it possible to detect movement of the target T.

For example, in the example shown in FIG. 1, the detection means 31 detects that (a) a free space optical communication path between the free space optical communication apparatuses 100-1 and 100-2 first interrupted by the target T and (b) the free space optical communication path between the free space optical communication apparatuses 100-4 and 100-5 is then interrupted by the target T. In this manner, the free space optical communication system 1 can monitor movement of the target T in a plane.

Note that the target T is an object whose movement is to be detected. The target T may be, for example, a person (an invader if the system is used for crime prevention; a pedestrian if the system is used for behavior analysis of a user of a facility) or another moving object. The target T in FIG. 1 is in the form of a person. However, the target T is not limited to a person.

There is no particular limitation on a place where the plurality of free space optical communication apparatuses 100 are provided. However, in a case where the free space optical communication system 1 is used for the purpose of crime prevention, the plurality of free space optical communication apparatuses 100 may be provided in a house or a facility which is a target of crime prevention, for example. Meanwhile, in a case where the free space optical communication system 1 is used for the purpose of behavior analysis of a user of a facility, the plurality of free space optical communication apparatuses 100 may be provided in the facility, for example. Further, it is preferable that the plurality of free space optical communication apparatuses 100 be provided so that a [symbol] : 13 free space optical communication path is formed in a position where the target T moves.

The detection means 31 may be provided in an apparatus different from the free space optical communication apparatus 100 or may be provided in the free space optical communication apparatuses 100. Alternatively, detection means 31 may be provided in an apparatus different from the free space optical communication apparatus 100 and in the free space optical communication apparatuses 100 so that the detection means 31 share the function.

### Example of Configuration of Management Apparatus

Here, the following will discuss, as an example, a configuration in which a detection means is provided in a management apparatus 200, which is another apparatus different from the free space optical communication apparatus 100. FIG. 2 is a block diagram schematically illustrating an example of a configuration of the management apparatus 200.

The management apparatus 200 is connected to a meshed-form free space optical communication network N, and is configured to be communicable with each of the free space optical communication apparatuses 100. The management apparatus 200 includes a detection means 231. The detection means 231 detects movement of the target T in the area of the meshed-form free space optical communication network N on the basis of light reception states of the respective plurality of free space optical communication apparatuses 100 constituting the meshed-form free space optical communication network N.

The management apparatus 200 may obtain the light reception states of the respective free space optical communication apparatuses 100 and detect movement of the target T in the area of the meshed-form free space optical communication network N on the basis of the light reception states of the respective free space optical communication apparatuses 100 thus obtained.

Further, as described later, in a case where each free space optical communication apparatus 100 includes the detection means 131 that detects movement of the target T which is in the vicinity of the free space optical communication apparatus 100, the management apparatus 200 may obtain detection results from the respective free space optical communication apparatuses 100 and detect movement of the target T in the area of the meshed-form free space optical communication network N on the basis of detection results which are based on the obtained light reception states of the respective free space optical communication apparatuses 100.

### Example of Configuration of Free Space Optical Communication Apparatus

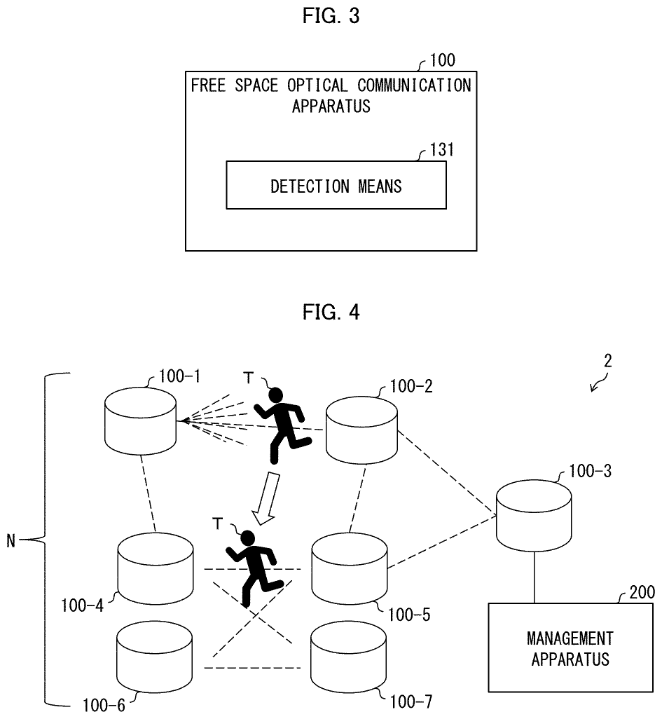

Next, the following will discuss, as an example, a configuration in which a detection means is provided in each of the free space optical communication apparatuses 100. FIG. 3 is a block diagram schematically illustrating an example of a configuration of the free space optical communication apparatus 100.

The free space optical communication apparatus 100 is included in the plurality of free space optical communication apparatuses 100 constituting the meshed-form free space optical communication network N. The free space optical communication apparatus 100 includes the detection means 131. The detection means 131 detects movement of the target

T which is in the vicinity of the free space optical communication apparatus 100 in the area of the meshed-form free space optical communication network N on the basis of the light reception state of the free space optical communication apparatus 100.

The expression “vicinity of the free space optical communication apparatus 100” means a space between the free space optical communication apparatus 100 and another free space optical communication apparatus 100 adjacent thereto. For example, in the example shown in FIG. 1, the free space optical communication apparatus 100-2 can detect movement of the target T in a space between the free space optical communication apparatuses 100-2 and 100-1, a space between the free space optical communication apparatuses 100-2 and 100-3, and a space between free space optical communication apparatuses 100-2 and 100-5.

Further, each free space optical communication apparatus 100 can notify, to another free space optical communication apparatus 100 or the management apparatus 200 (if present), a detection result given by the detection means 131 of the free space optical communication apparatus 100. This makes it possible to detect movement of the target T in the area of the meshed-form free space optical communication network N.

### Second Example Embodiment

The following description will discuss a second example embodiment of the present invention in detail with reference to the drawings. Note that members having identical functions to those of the first example embodiment are given identical reference signs, and a description thereof will be omitted.

### Configuration of Free Space Optical Communication System

The following will describe, with reference to FIG. 4, a configuration of a free space optical communication system 2 in accordance with the present example embodiment. FIG. 4 is a block diagram schematically illustrating an example of a configuration of the free space optical communication system 2. The free space optical communication system 2 includes a plurality of free space optical communication apparatuses 100 (free space optical communication apparatuses 100-1 to 100-7) constituting a meshed-form free space optical communication network N and a management apparatus 200.

The following description will discuss a configuration in which a function of a detection means that detects movement of a target T in an area of the meshed-form free space optical communication network N on the basis of light reception states of the respective free space optical communication apparatuses 100 is shared by detection means 131 included in the respective free space optical communication apparatuses 100 and a detection means 231 included in the management apparatus 200. That is, the detection means 131 included in each of the free space optical communication apparatuses 100 detects, on the basis of a light reception state of the free space optical communication apparatus 100, movement of a target T which is in the vicinity of the free space optical communication apparatus 100 in the area of the meshed-form free space optical communication network N. The detection means 231 included in the management apparatus 200 obtains detection results given by the detection means 131 included in the respective free space optical communication apparatus 100, and detects movement of the target T in the area of the meshed-form free space optical communication network N. With this, the function of the detection means that detects movement of the target T in the area of the meshed-form free space optical communication network N on the basis of the light reception states of the respective free space optical communication apparatus 100 can be realized by the detection means 131 included in the respective free space optical communication apparatuses 100 and the detection means 231 included in the management apparatus 200.

Note that the present example embodiment is not limited to this. Alternatively, the detection means 231 included in the management apparatus 200 may obtain the light reception states of the respective free space optical communication apparatuses 100 and detect movement of the target T in the area of the meshed-form free space optical communication network N on the basis of the light reception states of the respective free space optical communication apparatuses 100.

Further, the detection means 131 included in each free space optical communication apparatus 100 may be configured to exchange, with another free space optical communication apparatus 100, a detection result regarding movement of the target T which is in the vicinity of the free space optical communication apparatus 100. With this, the function of the detection means that detects movement of the target T in the area of the meshed-form free space optical communication network N on the basis of the light reception states of the respective free space optical communication apparatus 100 can be realized by the detection means 131 included in the respective free space optical communication apparatuses 100.

### Example of Configuration of Management Apparatus

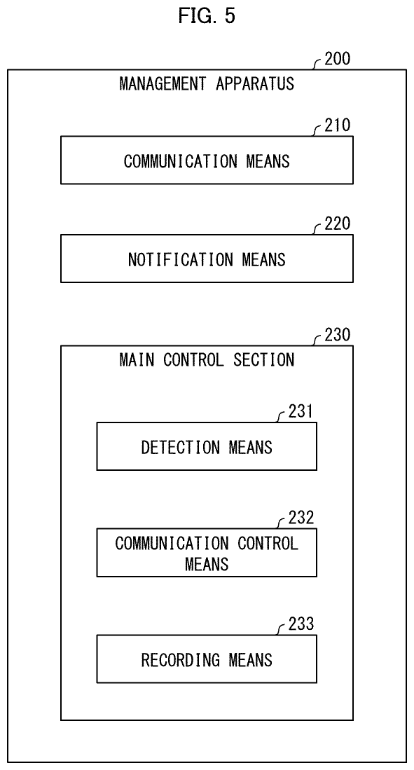

The following will describe, with reference to FIG. 5, a configuration of the management apparatus 200 in accordance with the present example embodiment. FIG. 5 is a block diagram schematically illustrating an example of a configuration of the management apparatus 200. The management apparatus 200 includes a communication means 210, a notification means 220, and a main control section 230. The main control section 230 includes the detection means 231, a communication control means 232, and a recording means 233.

The communication means 210 is connected to the meshed-form free space optical communication network N via any of the free space optical communication apparatuses 100 (in the example shown in FIG. 4, the free space optical communication apparatus 100-3), so as to communicate with the free space optical communication apparatuses 100. There is no particular limitation on a communication scheme between the management apparatus 200 and the free space optical communication apparatuses 100. The communication scheme may be a wired one or a wireless one.

The notification means 220 is a means that externally notifies a detection result given by the detection means 231. There is no particular limitation on a notification method. The notification means 220 may causes display of an image indicative of a detection result, may output an audio indicative of a detection result, or may transmit an electric signal indicative of a detection result.

The detection means 231 obtains detection results given by the detection means 131 included in the respective free space optical communication apparatus 100, and detects movement of the target T in the area of the meshed-form free space optical communication network N. The detection results given by the detection means 131 will be described in detail later.

The communication control means 232 controls free space optical communication in the meshed-form free space optical communication network N. The control will be described in detail later.

The recording means 233 records a detection result of the detection means 231 in time series. With this, it is possible to track movement of the target T. Note that, in a case where the detection means 131 included in the respective free space optical communication apparatuses 100 realize the function of the detection means that detects movement of the target T in the area of the meshed-form free space optical communication network N on the basis of the light received stats of the respective free space optical communication apparatuses 100, each of the free space optical communication apparatuses 100 may include a recording means that records a detection result of the detection means 131 in time series.

### Example of Configuration of Free Space Optical Communication Apparatus

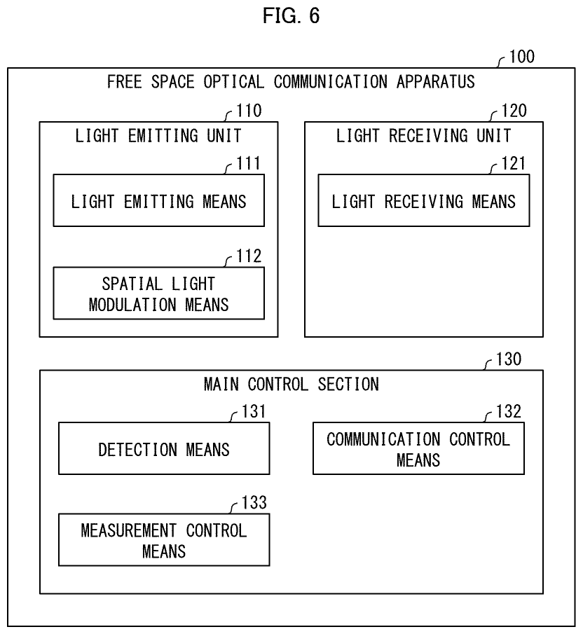

The following will describe, with reference to FIG. 6, a configuration of the free space optical communication apparatus 100 in accordance with the present example embodiment. FIG. 6 is a block diagram schematically illustrating an example of a configuration of the free space optical communication apparatus 100. The free space optical communication apparatus 100 includes a light emitting unit 110, a light receiving unit 120, and a main control section 130. The light emitting unit 110 includes a light emitting means 111 and a spatial light modulation means 112. The light receiving unit 120 includes a light receiving means 121. The main control section 130 includes the detection means 131, a communication control means 132, and a measurement control means 133.

The light emitting means 111 emits light. The light emitting means 111 can emit communication light for use in free space optical communication with another free space optical communication apparatus 100 and pulsed light for use in measurement of a shape of the target T. The communication light is continuous light on which a digital signal including a communication content is superimposed. The pulsed light is light having a higher intensity than that of the communication light and being emitted instantaneously. The light emitting means 111 includes a light emitting element and can include a lens and/or the like. Light emission of the light emitting means 111 is controlled by the communication control means 132 and the measurement control means 133. Light emitted from the light emitting means 111 enters the spatial light modulation means 112.

The spatial light modulation means 112 adjusts a direction of the light emitted by the light emitting means 111. The spatial light modulation means 112 is controlled by the communication control means 132 and the measurement control means 133.

The spatial light modulation means 112 is realized by, for example, a ferroelectric liquid crystal, a homogeneous liquid crystal, a vertically aligned liquid crystal, or the like, and includes, as an example, a liquid crystal on silicon (LCOS) device. The LCOS device has a plurality of light receiving regions that receive the light emitted from the light emitting means 111, and is configured to cause Fraunhofer diffraction. The communication control means 132 and the measurement control means 133 can control a voltage applied to each of the light receiving regions to control a refractive index of the light receiving region. With this, the communication control means 132 and the measurement control means 133 can cause a difference in the refractive index between the light receiving regions to appropriately diffract light which has entered the spatial light modulation means 112 from the light emitting means 111. In this manner, the spatial light modulation means 112 can adjust the direction of the light emitted by the light emitting means 111. In addition, the spatial light modulation means 112 can split the light emitted by the light emitting means 111 into a plurality of light beams and emit the light beams in mutually different directions.

The light receiving means 121 receives light from the outside. The light receiving means 121 can receive, as the light from the outside, (i) communication light from a communication counterpart of free space optical communication of the free space optical communication apparatus 100 and (ii) reflected light of communication light and pulsed light emitted by the free space optical communication apparatus 100. The light receiving means 121 includes a light receiving element and a reception circuit, and can include a condensing lens and the like. The light receiving means 121 can further include a determining unit that determines whether the received light is communication light from the communication counterpart of the free space optical communication of the free space optical communication apparatus 100, reflected light of communication light emitted from the free space optical communication apparatus 100, or reflected light of pulsed light emitted from the free space optical communication apparatus 100. Such determination can be made on the basis of a frequency, a light intensity, a timing, and/or the like.

The communication control means 132 causes the light emitting means 111 to emit communication light, and causes the light receiving means 121 to receive the communication light from the free space optical communication apparatus 100 which is a communication counterpart. In this manner, the communication control means 132 carries out free space optical communication with the free space optical communication apparatus 100 which is the communication counterpart. That is, the communication control means 132 controls the light emitting means 111 so that the light emitting means 111 emits communication light on which a digital signal including a communication content to be transmitted to the communication counterpart is superimposed. In this manner, the desired communication content is transmitted to the free space optical communication apparatus 100 which is the communication counterpart. Further, the communication control means 132 controls the light receiving means 121 so that the light receiving means 121 receives the communication light on which the digital signal including the communication content transmitted from the free space optical communication apparatus 100 which is the communication counterpart is superimposed. In this manner, the communication content transmitted from the communication counterpart is obtained.

The measurement control means 133 measures a shape of the target T in a surrounding area by (a) causing the light emitting means 111 to emit pulsed light in a plurality of directions and (b) causing the light receiving means 121 to receive reflected light of the pulsed light. That is, the measurement control means 133 controls the light emitting means 111 so that the light emitting means 111 emits pulsed light in a plurality of directions. The pulsed light thus emitted is reflected by the target T in the surrounding area. The measurement control means 133 causes the light receiving means 121 to receive reflected light of the pulsed light, so as to measure the shape of the target T in the surrounding area on the basis of the reflected light thus received. In other words, it is possible to cause the free space optical communication apparatus 100 to function like Light Detection And Ranging (LiDAR).

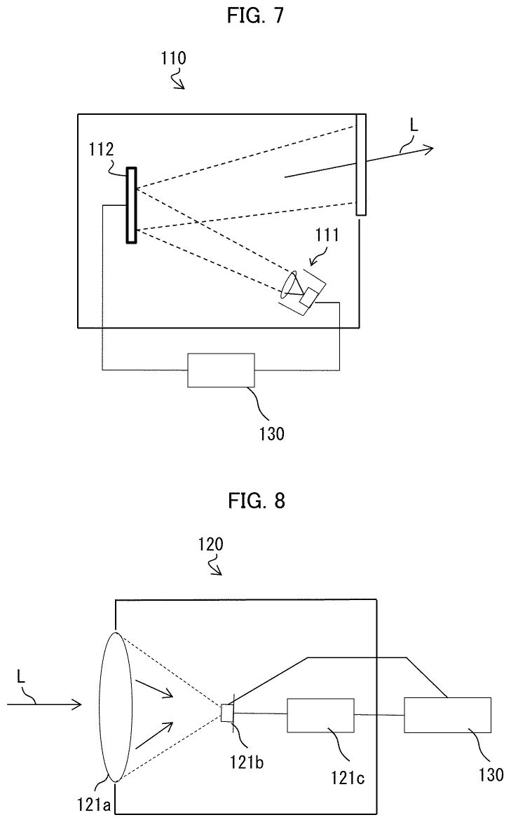

FIG. 7 is a view schematically illustrating an example of a configuration of the light emitting unit 110. As shown in FIG. 6, light L emitted from the light emitting means 111 enters the spatial light modulation means 112, a direction of the light L is adjusted by the spatial light modulation means 112, and the light exits from the light emitting unit 110. The light emitting means 111 and the spatial light modulation means 112 are controlled by the communication control means 132 and the measurement control means 133 of the main control section 130.

Note that the light emitting means 111 may include a light source which emits communication light and a light source which emits pulsed light. With this, light that is suitably used as the communication light and light that is suitably used as the pulsed light may be emitted.

FIG. 8 is a view schematically illustrating an example of a configuration of the light receiving unit 120. As shown in FIG. 6, the light receiving means 121 includes a condensing lens 121a, a light receiving element 121b, and a reception circuit (determining unit) 121c. Light L coming from the outside is condensed by the condensing lens 121a, and is received by the light receiving element 121b. Then, the light L received by the light receiving element 121b is detected by the reception circuit 121c. A detection result of the reception circuit 121c is supplied to the communication control means 132 and the measurement control means 133 of the main control section 130.

### Detection of Interruption of Free Space Optical Communication

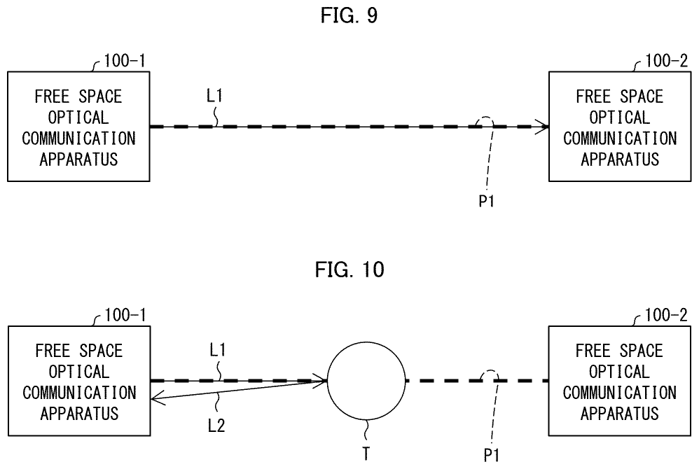

FIG. 9 is a view schematically illustrating an example of free space optical communication between two free space optical communication apparatuses 100 (free space optical communication apparatuses 100-1 and 100-2) in the free space optical communication system 2. The free space optical communication apparatuses 100-1 and 100-2 carry out free space optical communication on a free space optical communication path P1 between the free space optical communication apparatuses 100-1 and 100-2. In the example shown in FIG. 9, communication light L1 is transmitted from the free space optical communication apparatus 100-1 to the free space optical communication apparatus 100-2.

FIG. 10 is a view schematically illustrating an example where the free space optical communication between the two free space optical communication apparatuses 100 (free space optical communication apparatuses 100-1 and 100-2) shown in FIG. 9 is interrupted. When the free space optical communication on the free space optical communication path P1 between the free space optical communication apparatuses 100-1 and 100-2 is interrupted, the communication light L1 emitted from the free space optical communication apparatus 100-1 is reflected and is received by the free space optical communication apparatus 100-1 as reflected light L2. Thus, the detection means 131 of the free space optical communication apparatus 100-1 may detect movement of the target T, i.e., that the target T has moved across the free space optical communication path P1, on the basis of the free space optical communication apparatus 100-1′s reception of the reflected light of the light emitted from the free space optical communication apparatus 100-1 itself.

Further, when the free space optical communication on the free space optical communication path P1 between the free space optical communication apparatuses 100-1 and 100-2 is interrupted by the target T, the communication light L1 emitted from the free space optical communication apparatus 100-1 would not arrive at the free space optical communication apparatus 100-2. Thus, the detection means 131 of the free space optical communication apparatus 100-2 may detect movement of the target T, i.e., that the target T has moved across the free space optical communication path P1, on the basis of non-arrival of the communication light L at the free space optical communication apparatus 100-2, the communication light L having been emitted from the communication counterpart (free space optical communication apparatus 100-1) toward the free space optical communication apparatus 100-2.

### First Example Control of Free Space Optical Communication System

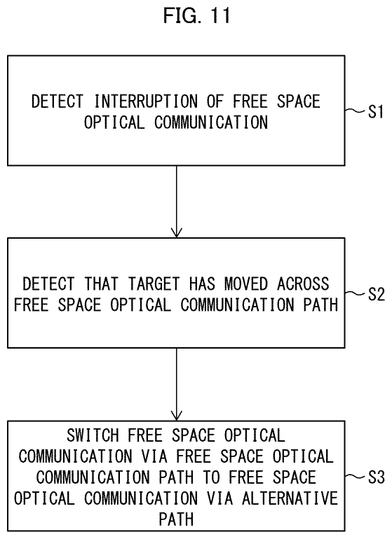

The following will describe, with reference to FIG. 11, an example control of the free space optical communication system 2 in accordance with the present example embodiment. FIG. 11 is a flowchart schematically illustrating a first example control of the free space optical communication system 2.

In the first example control, the free space optical communication system 2 is configured such that, when free space optical communication on a free space optical communication path between two free space optical communication apparatuses 100 is interrupted, (i) the detection means 131 detects that a target T has moved across the free space optical communication path and (ii) the communication control means 132 switches the free space optical communication carried out via the free space optical communication path to free space optical communication carried out via an alternative path.

First, the detection means 131 of the free space optical communication apparatus 100 detects interruption of the free space optical communication on the free space optical communication path on the basis of a light reception state of the free space optical communication apparatus 100 (step S1). Then, on the basis of the detection of the interruption of the free space optical communication, the detection means 131 detects that the target T has moved across the free space optical communication path (step S2).

Note that, in a configuration in which the detection means 231 included in the management apparatus 200 obtains light reception states of the respective free space optical communication apparatuses 100 and detects movement of the target T in the area of the meshed-form free space optical communication network N on the basis of the light reception states of the respective free space optical communication apparatuses 100, steps S1 and S2 may be executed by the detection means 231.

Subsequently, the communication control means 132 switches the free space optical communication carried out via the free space optical communication path across which the target T has moved to free space optical communication carried out via an alternative path that substitutes for the free space optical communication path. This makes it possible to maintain the free space optical communication, even if a part of the free space optical communication paths of the meshed-form free space optical communication network N is interrupted by the target T.

For example, assume that, in the example shown in FIG. 4, free space optical communication is carried out via the free space optical communication path between the free space optical communication apparatuses 100-1 and 100-2. In a case where the target T interrupts the free space optical communication on the free space optical communication path between the free space optical communication apparatuses 100-1 and 100-2, the communication control means 132 of the free space optical communication apparatus 100-1 may carry out switching of the free space optical communication between the free space optical communication apparatuses 100-1 and 100-2 so that free space optical communication is carried out via an alternative path extending from the free space optical communication apparatus 100-1 to the free space optical communication apparatus 100-2 via the free space optical communication apparatuses 100-4 and 100-5, in place of the free space optical communication path between the free space optical communication apparatuses 100-1 and 100-2. Then, in a case where the target T moves to interrupt the free space optical communication on the free space optical communication path between the free space optical communication apparatuses 100-4 and 100-5, the communication control means 132 of the free space optical communication apparatus 100-1 may carry out switching so that the free space optical communication is carried out via the free space optical communication path between the free space optical communication apparatuses 100-1 and 100-2, in place of the free space optical communication carried out via the free space optical communication path extending from the free space optical communication apparatus 100-1 to the free space optical communication apparatus 100-2 via the free space optical communication apparatuses 100-4 and 100-5.

For example, the communication control means 132 may store, in advance, a structure of the meshed-form free space optical communication network N (a connection relation between the free space optical communication apparatuses 100) and calculate the alternative path on the basis of the structure of the meshed-form free space optical communication network N.

Note that, in place of the communication control means 132, the communication control means 232 of the management apparatus 200 may switch the free space optical communication carried out via the free space optical communication path across which the target T has moved to the free space optical communication carried out via the alternative path that substitutes for the free space optical communication path.

A conventional meshed-form free space optical communication network is provided at a position where interruption of free space optical communication does not occur as much as possible, e.g., at a high position. Meanwhile, the meshed-form free space optical communication network N of the free space optical communication system 2 in accordance with the present example embodiment is provided at a position place across which the target T (e.g., a person) may move, in order that movement of the target T can be detected. According to the first example control, the communication control means 132 or 232 switches free space optical communication carried out via the free space optical communication path across which the target T has moved to the free space optical communication carried out via the alternative path that substitutes for the free space optical communication path. This makes it possible to maintain the free space optical communication, even if the meshed-form free space optical communication network N is provided at a position across which the target T may move.

### Second Example Control of Free Space Optical Communication System

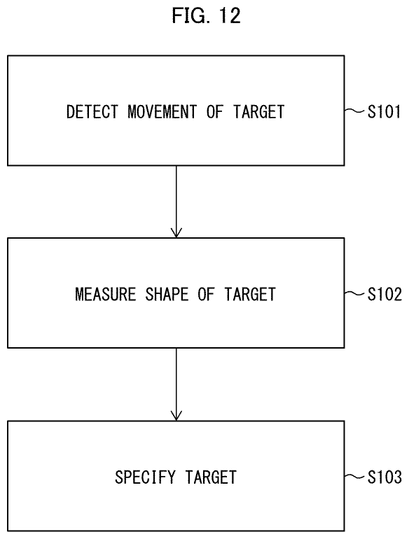

The following will describe, with reference to FIG. 12, another example control of the free space optical communication system 2 in accordance with the present example embodiment. FIG. 12 is a flowchart schematically illustrating a second example control of the free space optical communication system 2.

In the second example control, when the detection means 131 of the free space optical communication apparatus 100 detects movement of a target T, the detection means 131 causes the measurement control means 133 of the free space optical communication apparatus 100 to measure a shape of the target T. Then, on the basis of a result of the measurement, the detection means 131 executes at least one of specification (identification) of the target T, specification of a position of the target T, specification of the number of the targets T, and specification of an orientation of the target T.

First, the detection means 131 of the free space optical communication apparatus 100 may detect movement of the target T by detecting interruption of free space optical communication on a free space optical communication path on the basis of a light reception state of the free space optical communication apparatus 100 (step S101).

During this, the detection means 131 of the free space optical communication apparatus 100 may cause the measurement control means 133 of the free space optical communication apparatus 100 to measure a shape of the target T (step S102).

Then, on the basis of a result of the measurement carried out by the measurement control means 133, the detection means 131 of the free space optical communication apparatus 100 may execute at least one of specification (identification) of the target T, specification of a position of the target T, specification of the number of the targets T, and specification of an orientation of the target T (step S103).

The specification of the target T may be, for example, determination of identicalness of the target T. For example, in the example shown in FIG. 4, the specification of the target T may be determination of whether or not a target T (e.g., an invader) who has moved across the optical communication path between the free space optical communication apparatuses 100-1 and 100-2 is identical (identical person) to a target T (e.g., an invader) who has moved across the optical communication path between the free space optical communication apparatuses 100-4 and 100-5. Note that the specification of the target T may identify what the target T is.

Note that the second example control may be executed by the detection means 231 of the management apparatus 200. First, the detection means 231 may detect movement of the target T on the basis of a light reception state of any of the free space optical communication apparatuses 100 or a detection result given by the detection means 131 of any of the free space optical communication apparatuses 100 (step S101).

During time, the detection means 231 may cause the measurement control means 133 of the free space optical communication apparatus 100 to measure a shape of the target T (step S102).

Then, on the basis of a result of the measurement carried out by the measurement control means 133, the detection means 231 may execute at least one of specification (identification) of the target T, specification of a position of the target T, specification of the number of the targets T, and specification of an orientation of the target T (step S103).

For example, in the example shown in FIG. 4, when the target T interrupts the free space optical communication on the free space optical communication path between the free space optical communication apparatuses 100-1 and 100-2, the detection means 131 of the free space optical communication apparatus 100-1 or the detection means 231 of the management apparatus 200 causes the measurement control means 133 of the free space optical communication apparatus 100-1 to measure a shape of an object existing in a surrounding area, thereby measuring a shape of the target T. The detection means 131 of the free space optical communication apparatus 100-1 or the detection means 231 of the management apparatus 200 specifies the target T on the basis of a measurement result given by the measurement control means 133 of the free space optical communication apparatus 100-1. Thereafter, when the target T interrupts the free space optical communication on the free space optical communication path between the free space optical communication apparatuses 100-4 and 100-5, the detection means 131 of the free space optical communication apparatus 100-4 or the detection means 231 of the management apparatus 200 causes the measurement control means 133 of the free space optical communication apparatus 100-4 to measure a shape of an object existing in a surrounding area, thereby measuring a shape of the target T. The detection means 131 of the free space optical communication apparatus 100-4 or the detection means 231 of the management apparatus 200 specifies the target T on the basis of a measurement result given by the measurement control means 133 of the free space optical communication apparatus 100-4. Then, comparison is made between (i) a result of specification of the target T carried out when the free space optical communication on the free space optical communication path between the free space optical communication apparatuses 100-1 and 100-2 is interrupted and (ii) a result of specification of the target T carried out when the free space optical communication on the free space optical communication path between the free space optical communication apparatuses 100-4 and 100-5. If these results match with each other, it is possible to determine (track) that the same target T has moved from a position on the free space optical communication path between the free space optical communication apparatuses 100-1 and 100-2 to a position on the free space optical communication path between the free space optical communication apparatuses 100-4 and 100-5.

As described above, the second example control is configured such that, while the target T is moving in the vicinity of the free space optical communication apparatus 100, the free space optical communication apparatus 100 is caused to function like LiDAR so as to specify at least one of the target T, a position of the target T, the number of the targets T, and an orientation of the target T. This makes it possible to obtain specific information of the target T while reducing electric power cost as compared to a configuration in which LiDAR is always ON. Particularly, specifying the target T enables accurate tracking of the target T.

### Third Example Embodiment

The following description will discuss a third example embodiment of the present invention in detail with reference to the drawings. Note that members having identical functions to those of the first or second example embodiment are given identical reference signs, and a description thereof will be omitted.

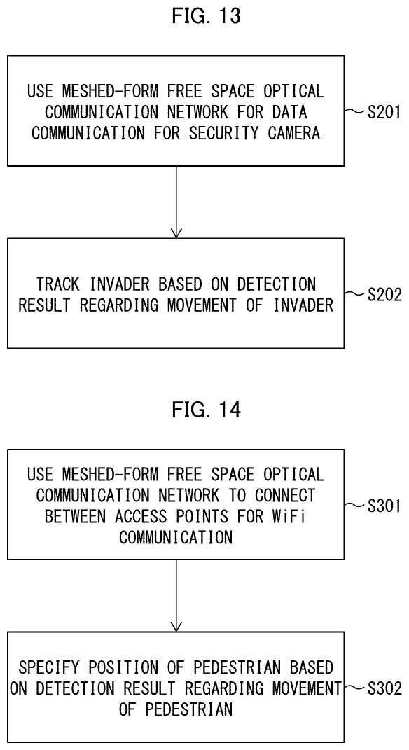

The following will describe, with reference to FIG. 13, an example control of a free space optical communication system 2 in accordance with the present example embodiment. FIG. 13 is a flowchart schematically illustrating a third example control of the free space optical communication system 2.

In the third example control, the free space optical communication system 2 can be used for crime prevention, for example. A target T may be, for example, an invader. In step S201, a communication control means 232 of a management apparatus 200 uses a meshed-form free space optical communication network N to carry out data communication for a security camera. Note that the present example embodiment is not limited to this. Alternatively, the meshed-form free space optical communication network N may be used for another purpose.

Then, in step S202, it is possible to track an invader in an area of the meshed-form free space optical communication network N on the basis of a detection result regarding movement of the target T, the detection result being given by a detection means 131 or 231. For example, by recording movement of the target T in time series, a recording means 233 can track an invader in time series. Further, by measuring a shape of the target T in a manner similar to that carried out in the second example control, the measurement control means 133 can specify the invader. With the above configuration, it is possible to enhance the crime prevention effect.

### Fourth Example Embodiment

The following description will discuss a fourth example embodiment of the present invention in detail with reference to the drawings. Note that members having identical functions to those of the first to third example embodiments are given identical reference signs, and a description thereof will be omitted.

The following will describe, with reference to FIG. 14, an example control of a free space optical communication system 2 in accordance with the present example embodiment. FIG. 14 is a flowchart schematically illustrating a fourth example control of the free space optical communication system 2.

In the fourth example control, the free space optical communication system 2 can be used for behavior analysis of a user of a facility, for example. A target T may be, for example, a pedestrian. In step S301, a communication control means 232 of a management apparatus 200 uses a meshed-form free space optical communication network N to connect between access points for WiFi communication. Note that the present example embodiment is not limited to this. Alternatively, the meshed-form free space optical communication network N may be used for another purpose.

Then, in step S302, it is possible to specify a position of the pedestrian on the basis of a detection result regarding movement of the target T, the detection result being given by a detection means 131 or 231. For example, by recording movement of the target T in time series, the recording means 233 can collect a position of the pedestrian in time series. Further, by measuring a shape of the target T in a manner similar to that carried out in the second example control, a measurement control means 133 can specify the pedestrian. With the above configuration, it is possible to enhance accuracy in the behavior analysis of the user of the facility.

### Fifth Example Embodiment

The following description will discuss a fifth example embodiment of the present invention in detail with reference to the drawings. Note that members having identical functions to those of the first to fourth example embodiments are given identical reference signs, and a description thereof will be omitted.

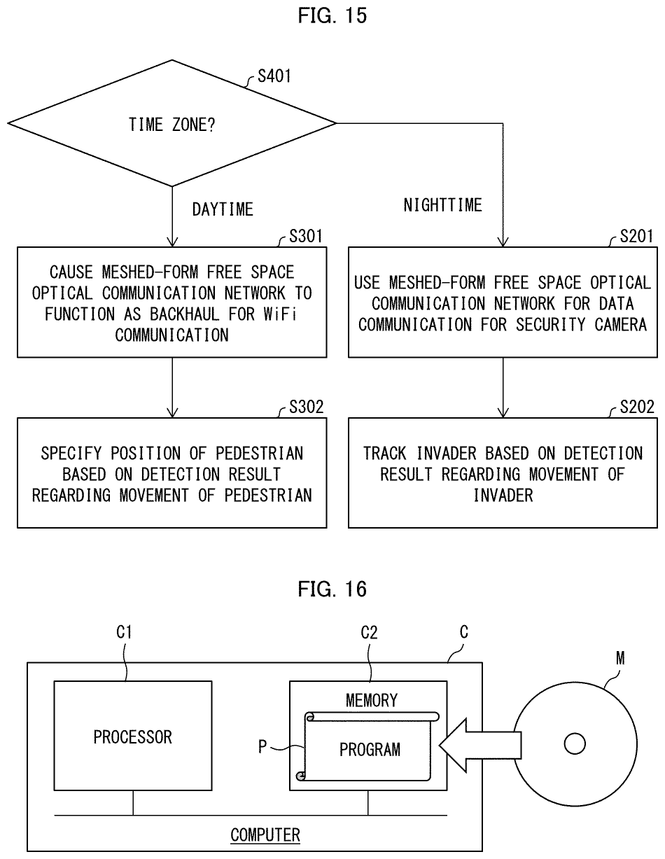

The following will describe, with reference to FIG. 15, an example control of a free space optical communication system 2 in accordance with the present example embodiment. FIG. 15 is a flowchart schematically illustrating a fifth example control of the free space optical communication system 2.

In the fifth example control, a purpose of use of the free space optical communication system 2 can be switched from one to another according to a time. In step S401, a communication control means 232 of a management apparatus 200 determines whether it is a time zone (daytime) in which an unspecified number of users exist in an area where the meshed-form free space optical communication network N is provided or a time zone (nighttime) in which no user exists in the area generally.

In a case where the time zone is daytime, steps S301 and S302 explained in the fourth example embodiment are executed. Meanwhile, in a case where the time zone is nighttime, steps S201 and S202 explained in the third example embodiment are executed. As described above, in the fifth example control, it is possible to switch, according to a time, whether an invader in an area of the meshed-form free space optical communication network N is to be tracked on the basis of a detection result given by the detection means 131 or 231 or a position of a pedestrian in the area of the meshed-form free space optical communication network N is to be specified on the basis of a detection result given by the detection means 131 or 231. With this, it is possible to use the free space optical communication system 2 for a purpose according to a time zone.

### Software Implementation Example

Part of or the whole of functions of the free space optical communication systems 1 and 2 can be realized by hardware such as an integrated circuit (IC chip) or can be alternatively realized by software.

In the latter case, the free space optical communication apparatus 100 and the management apparatus 200 are realized by, for example, a computer that executes instructions of a program that is software realizing the foregoing functions. FIG. 10 shows an example of such a computer (hereinafter, referred to as a “computer C”). The computer C includes at least one processor C1 and at least one memory C2. The memory C2 has a program P stored therein, the program P causing the computer C to operate as the free space optical communication apparatus 100 or the management apparatus 200. In the computer C, the processor C1 reads and executes the program P from the memory C2, thereby realizing the functions of the free space optical communication apparatus 100 or the management apparatus 200.

The processor C1 may be, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination of any of them. The memory C2 may be, for example, a flash memory, hard disk drive (HDD), solid state drive (SSD), or a combination of any of them.

The computer C may further include a random access memory (RAM) in which the program P is loaded when executed and various data is temporarily stored. In addition, the computer C may further include a communication interface via which the computer C transmits/receives data to/from another device. The computer C may further include an input-output interface via which the computer C is connected to an input-output device such as a keyboard, a mouse, a display, and/or a printer.

The program P can be stored in a non-transitory, tangible storage medium M capable of being read by a computer C. Examples of the storage medium M encompass a tape, a disk, a card, a semiconductor memory, and a programmable logic circuit. The computer C can obtain the program P via the storage medium M. Alternatively, the program P can be transmitted via a transmission medium. Examples of such a transmission medium encompass a communication network and a broadcast wave. The computer C can also obtain the program P via the transmission medium.

### Supplementary Remarks 1

The present invention is not limited to the foregoing example embodiments, but can be altered by a skilled person in the art within the scope of the claims. The present invention also encompasses, in its technical scope, any embodiment derived by combining technical means disclosed in differing embodiments.

### Supplementary Remarks 2

Some or all of the foregoing example embodiments can be described as below. Note, however, that the present invention is not limited to aspects described below.

### Supplementary Note 1

A free space optical communication system including: a plurality of free space optical communication apparatuses constituting a meshed-form free space optical communication network; and at least one processor, the at least one processor executing a detection process of detecting movement of a target in an area of the meshed-form free space optical communication network on a basis of light reception states of the respective plurality of free space optical communication apparatuses.

### Supplementary Note 2

The free space optical communication system described in Supplementary Note 1, wherein: the at least one processor executes a communication control process of controlling free space optical communication in the meshed-form free space optical communication network; and in a case where free space optical communication on a free space optical communication path between two of the plurality of free space optical communication apparatuses is interrupted, (a) the at least one processor detects, in the detection process, that the target has moved across the free space optical communication path, and (b) the at least one processor switches, in the communication control process, the free space optical communication carried out via the free space optical communication path to free space optical communication carried out via an alternative path.

### Supplementary Note 3

The free space optical communication system described in Supplementary Note 1 or 2, wherein: the at least one processor executes a measurement control process of measuring a shape of an object in an area surrounding one of the plurality of free space optical communication apparatuses by (a) causing the one of the plurality of free space optical communication apparatuses to emit pulsed light in a plurality of directions and (b) causing the one of the plurality of free space optical communication apparatuses to receive reflected light of the pulsed light; and in a case where the at least one processor detects movement of the target in the detection process, the at least one processor measures, in the measurement control process, a shape of the target and specifies, on a basis of a result of the measurement, at least one of the target, a position of the target, the number of the targets, and an orientation of the target.

### Supplementary Note 4

The free space optical communication system described in any one of Supplementary Notes 1 to 3, wherein: in the detection process, the at least one processor detects movement of the target on a basis of, for each of the plurality of free space optical communication apparatuses, at least one of (a) the free space optical communication apparatus's reception of reflected light of light emitted from the free space optical communication apparatus itself and (b) non-arrival of light at the free space optical communication apparatus, the light having been emitted from a communication counterpart of the free space optical communication apparatus toward the free space optical communication apparatus.

### Supplementary Note 5

The free space optical communication system described in any one of Supplementary Notes 1 to 4, wherein: the at least one processor further executes a recording process of recording, in time series, a detection result given by the detection process.

### Supplementary Note 6

The free space optical communication system described in any one of Supplementary Notes 1 to 5, wherein: the at least one processor tracks an invader in the area of the meshed-form free space optical communication network on a basis of a detection result given by the detection process.

### Supplementary Note 7

The free space optical communication system described in any one of Supplementary Notes 1 to 5, wherein: the at least one processor specifies a position of a pedestrian in the area of the meshed-form free space optical communication network on a basis of a detection result given by the detection process.

### Supplementary Note 8

The free space optical communication system described in any one of Supplementary Notes 1 to 5, wherein: the at least one processor switches, according to a time, whether an invader in the area of the meshed-form free space optical communication network is to be tracked on a basis of a detection result given by the detection means or a position of a pedestrian in the area of the meshed-form free space optical communication network is to be specified on a basis of a detection result given by the detection means.

### Supplementary Note 9

A management apparatus including: at least one processor, the at least one processor executing a detection process of detecting movement of a target in an area of a meshed-form free space optical communication network on a basis of light reception states of a respective plurality of free space optical communication apparatuses constituting the meshed-form free space optical communication network.

### Supplementary Note 10

A free space optical communication apparatus which is included in a plurality of free space optical communication apparatuses constituting a meshed-form free space optical communication network, the free space optical communication apparatus including: at least one processor, the at least one processor executing a detection process of detecting, on a basis of a light reception state of the free space optical communication apparatus, movement of a target which is in a vicinity of the free space optical communication apparatus in an area of the meshed-form free space optical communication network.

### Supplementary Note 11

A free space optical communication system including: a plurality of free space optical communication apparatuses constituting a meshed-form free space optical communication network; and at least one processor, the at least one processor executing: a detection process of detecting movement of a target in an area of the meshed-form free space optical communication network on a basis of light reception states of the respective plurality of free space optical communication apparatuses.

Note that the free space optical communication system may further include a memory. In the memory, a program causing the processor to execute the detecting process may be stored. The program may can be stored in a non-transitory, tangible storage medium capable of being read by a computer.

### Reference Signs List

1: free space optical communication system
31, 131, 231: detection means
100: free space optical communication apparatus
132, 232: communication control means
133: measurement control means
200: management apparatus
233: recording means
N: meshed-form free space optical communication network
T: target

1. A free space optical communication system comprising:
a plurality of free space optical communication apparatuses constituting a meshed-form free space optical communication network; and
at least one processor,
the at least one processor executing a detection process of detecting movement of a target in an area of the meshed-form free space optical communication network on a basis of light reception states of the respective plurality of free space optical communication apparatuses.

2. The free space optical communication system according to claim 1, wherein:
the at least one processor executes a communication control process of controlling free space optical communication in the meshed-form free space optical communication network; and
in a case where free space optical communication on a free space optical communication path between two of the plurality of free space optical communication apparatuses is interrupted, (a) the at least one processor detects, in the detection process, that the target has moved across the free space optical communication path and (b) the at least one processor switches, in the communication control process, the free space optical communication carried out via the free space optical communication path to free space optical communication carried out via an alternative path.

3. The free space optical communication system according to claim 1, wherein:
the at least one processor executes a measurement control process of measuring a shape of an object in an area surrounding one of the plurality of free space optical communication apparatuses by (a) causing the one of the plurality of free space optical communication apparatuses to emit pulsed light in a plurality of directions and (b) causing the one of the plurality of free space optical communication apparatuses to receive reflected light of the pulsed light; and
in a case where the at least one processor detects movement of the target in the detection process, the at least one processor measures, in the measurement control process, a shape of the target and specifies, on a basis of a result of the measurement, at least one of the target, a position of the target, the number of the targets, and an orientation of the target.

4. The free space optical communication system according to claim 1, wherein:
in the detection process, the at least one processor detects movement of the target on a basis of, for each of the plurality of free space optical communication apparatuses, at least one of (a) the free space optical communication apparatus's reception of reflected light of light emitted from the free space optical communication apparatus itself and (b) non-arrival of light at the free space optical communication apparatus, the light having been emitted from a communication counterpart of the free space optical communication apparatus toward the free space optical communication apparatus.

5. The free space optical communication system according to claim 1, wherein:
the at least one processor further executes a recording process of recording, in time series, a detection result given by the detection process.

6. The free space optical communication system according to claim 1, wherein:
the at least one processor tracks an invader in the area of the meshed-form free space optical communication network on a basis of a detection result given by the detection process.

7. The free space optical communication system according to claim 1, wherein:
the at least one processor specifies a position of a pedestrian in the area of the meshed-form free space optical communication network on a basis of a detection result given by the detection process.

8. The free space optical communication system according to claim 1, wherein:
the at least one processor switches, according to a time, whether an invader in the area of the meshed-form free space optical communication network is to be tracked on a basis of a detection result given by the detection process or a position of a pedestrian in the area of the meshed-form free space optical communication network is to be specified on a basis of a detection result given by the detection process.

9. A management apparatus comprising:
at least one processor,
the at least one processor executing a detection process of detecting movement of a target in an area of a meshed-form free space optical communication network on a basis of light reception states of a respective plurality of free space optical communication apparatuses constituting the meshed-form free space optical communication network.

10. The management apparatus according to claim 9, wherein:
the at least one processor executes a communication control process of controlling free space optical communication in the meshed-form free space optical communication network; and
in a case where free space optical communication on a free space optical communication path between two of the plurality of free space optical communication apparatuses is interrupted, (a) the at least one processor detects, in the detection process, that the target has moved across the free space optical communication path and (b) the at least one processor switches, in the communication control process, the free space optical communication carried out via the free space optical communication path to free space optical communication carried out via an alternative path.

11. The management apparatus according to claim 9, wherein:
the at least one processor executes a measurement control process of measuring a shape of an object in an area surrounding one of the plurality of free space optical communication apparatuses by (a) causing the one of the plurality of free space optical communication apparatuses to emit pulsed light in a plurality of directions and (b) causing the one of the plurality of free space optical communication apparatuses to receive reflected light of the pulsed light; and
in a case where the at least one processor detects movement of the target in the detection process, the at least one processor measures, in the measurement control process, a shape of the target and specifies, on a basis of a result of the measurement, at least one of the target, a position of the target, the number of the targets, and an orientation of the target.

12. The management apparatus according to claim 9, wherein:
in the detection process, the at least one processor detects movement of the target on a basis of, for each of the plurality of free space optical communication apparatuses, at least one of (a) the free space optical communication apparatus's reception of reflected light of light emitted from the free space optical communication apparatus itself and (b) non-arrival of light at the free space optical communication apparatus, the light having been emitted from a communication counterpart of the free space optical communication apparatus toward the free space optical communication apparatus.

13. The management apparatus according to claim 9, wherein:
the at least one processor further executes a recording process of recording, in time series, a detection result given by the detection process.

14. The management apparatus according to claim 9, wherein:
the at least one processor tracks an invader in the area of the meshed-form free space optical communication network on a basis of a detection result given by the detection process.

15. The management apparatus according to claim 9, wherein:
the at least one processor specifies a position of a pedestrian in the area of the meshed-form free space optical communication network on a basis of a detection result given by the detection process.

16. The management apparatus according to claim 9, wherein:
the at least one processor switches, according to a time, whether an invader in the area of the meshed-form free space optical communication network is to be tracked on a basis of a detection result given by the detection process or a position of a pedestrian in the area of the meshed-form free space optical communication network is to be specified on a basis of a detection result given by the detection process.

17. A free space optical communication apparatus which is included in a plurality of free space optical communication apparatuses constituting a meshed-form free space optical communication network, the free space optical communication apparatus comprising:
at least one processor,
the at least one processor executing a detection process of detecting, on a basis of a light reception state of the free space optical communication apparatus, movement of a target which is in a vicinity of the free space optical communication apparatus in an area of the meshed-form free space optical communication network.
